(19) United States
(12) Patent Application Publication
(10) Pub. No.: US 2004/0228937 A1
(43) Pub. Date: Nov. 18, 2004

(54) Comb element with a surface structure set back from the involute surface

(75) Inventors: Joachim Ruch, Stuttgart (DE); Hans-Gerhard Fritz, Uhingen (DE); Matthias Abendschein, Albstadt (DE)

Correspondence Address: HENRY M FEIEREISEN, LLC, 350 FIFTH AVENUE, SUITE 4714, NEW YORK, NY, 10118, US

(73) Assignee: KRAUSS-MAFFEI KUNSTSTOFFTECHNIK GMBH, Munchen (DE)

(21) Appl. No.: 10/801,485

(22) Filed: Mar. 16, 2004

Related U.S. Application Data
(63) Continuation of application No. PCT/EP02/10726, filed on Sep. 25, 2002.

(30) Foreign Application Priority Data
Oct. 2, 2001 (DE) 101 49 765.2

(51) Int. Cl. B29C 47/38

(52) U.S. Cl. 425/204; 425/209

(57) ABSTRACT

Screw elements for twin-screw extruders are mounted on shafts which rotate in a same direction, with the screw elements having closely intermeshing outer contour for enabling a gentle incorporation of the fibers, in particular natural fibers in plastic melts and maintaining a longest possible fiber length. In the area of the surface of the screw elements, a plurality of surface structure elements are disposed which do not project beyond the outer contour of the screw element.

### CROSS-REFERENCES TO RELATED APPLICATIONS

This application is a continuation of prior filed copending PCT International application no. PCT/EP02/10726, filed Sep. 25, 2002, which designated the United States and on which priority is claimed under 35 U.S.C. §120, the disclosure of which is hereby incorporated by reference.

This application claims the priority of German Patent Application, Serial No. 101 49 765.2, filed Oct. 2, 2001, pursuant to 35 U.S.C. 119(a)-(d), the disclosure of which is incorporated herein by reference.

### BACKGROUND OF THE INVENTION

The present invention relates, in general, to twin-screw extruders of a type having closely intermeshing extruder screw elements rotating in same direction.

Screw elements typically used in extruders of this type are disposed on respective screw shafts to form the screws and are characterized by a closely intermeshing involute surface to carry out mixing, kneading and conveying operations in a wide variety of sequences. The involute surfaces or outer contours, used hereby, are disclosed, for example, in M. L. Booy, Polymer Engineering and Science, September 1978, volume 18, p. 9730984.

It is further known to incorporate fiber materials in plastic melts during their extrusion. The incorporation of fiber materials should hereby be as even as possible, while attaining a greatest possible fiber length to thereby realize a maximum reinforcement effect in the plastic material. An even distribution of the fibers in the plastic material can, however, be realized to date only by constructing the extruder of relatively long length. Thus, mixing and kneading operations take a long time and increase the risk in fiber fractures as well as a thermal degradation of the fibers, in particular when natural fibers are involved, which ultimately leads to fouling odor so that the use of natural fibers for many applications is limited.

It would therefore be desirable and advantageous to provide an improved screw element to obviate prior art shortcomings and to effect a gentle incorporation of fibers, in particular also of natural fibers, in plastic melts while still realizing a longest possible fiber length.

### SUMMARY OF THE INVENTION

According to one aspect of the present invention, a comb element with closely intermeshing involute surface for a twin-screw extruder with closely intermeshing screws that rotate in a same direction, has on the involute surface a plurality of surface structure elements which are set back from the involute surface. The involute surface does hereby not constitute the actual outer surface of the comb elements which is structured in a wide variety as a consequence of the provision of the surface structure elements.

Each of the screw elements constructed in accordance with the invention has a base body which can be configured in principle in all known cross sectional geometries, as disclosed, for example, in the afore-mentioned printed publication. Furthermore, also circular base bodies are appropriate so long it is ensured that the involute surfaces closely intermesh. A closely intermeshing state is assumed within the scope of the present invention in particular when the distance between the involute surfaces of the comb elements amounts to a maximum of 5 mm.

The comb elements according to the invention thus involve closely intermeshing elements, relating, however, only to the involute surfaces of the elements but not to the actual surface of the comb elements with the incorporated surface structure elements. In other words, the comb elements are configured with their base body in closely intermeshing manner in the absence of an intermeshing contact of the individual surface structure elements of both screws, disposed in side-by-side relationship on the parallel screw shafts. In this way, the possibility of cutting motions is prevented, and the fibers are combed apart only at the surface of the screw elements.

It is possible to provide the base bodies with closely intermeshing elements having 1 to 4 melt channels. Conceivable and possible, however, are also elements with more melt channels or, as stated above, with circular geometry. It is only important that the involute surfaces closely intermesh in the intermeshing zone, i.e. as stated above, at a maximum distance of 5 mm.

According to another feature of the present invention, the comb element may have surface structure elements that extend inwardly at most by 5 mm from the involute surface of the comb element in perpendicular relationship to the tangential direction. This prevents formation of excessive indentations in the involute surfaces of the comb elements in which fiber parts may penetrate and more or less trapped therein. The slight depth of the surface structure elements perpendicular to the tangential direction of the involute surfaces ensures that fibers migrated into the free spaces between neighboring surface structure elements can be transported out again from this indentation and thus do not become trapped in the comb element.

According to another feature of the present invention, the comb element may be provided with surface structure elements having a surface at the tip of the individual surface structure element, i.e. next to the involute surface of the comb element, of ≦2 mm², preferably ≦1.8 mm². This enables a particularly effective penetration of the tips of the surface structure elements in the fiber composites that are supplied to the extruder for processing. Thus, a “combing out” of single fibers from the fiber composite and their distribution in the plastic melt is possible in a shortest possible time.

According to another feature of the present invention, the surface structure elements may each have a base body constructed to resemble the shape of a pyramid, truncated pyramid, cone, truncated cone, cylinder or block shape, or even combinations thereof. Suitably, the surface structure elements may have a cross section which decreases from inside to the outside, i.e. in the direction of the involute surface. Conical structures such as encountered in cones or pyramids are preferred. This enables in particular an easy penetration of the surface structure elements into the fiber materials (rovings) but also an unproblematic release of these materials into the surrounding plastic melt and thus promotes a fastest possible and effective homogenous distribution of these materials in the surrounding plastic melt.

According to another feature of the present invention, the comb element may have a surface density of surface structure elements such as to realize at least 10⁸ looping possibilities per area unit of 100 mm² for a flexible fiber. Further preferred is a number of looping possibilities of 10¹² and more.

The comb elements according to the invention can be so constructed as to have an involute surface which ensures in the assembled state of two adjacent comb elements, mounted on parallel screw shafts, a distance of maximum 5 mm at their involute surfaces in the intermeshing zone.

The comb elements according to the invention can be made in such a manner that one comb element is made with the desired involute surface and then surface structure elements are incorporated in the involute surface through material removal.

As an alternative, also a comb element may be used as starting point which has smaller dimensions than the targeted involute surface. The latter is realized only through provision of the surface structure elements upon the surface of the original comb element.

According to another aspect of the present invention, a twin-screw extruder includes closely intermeshing screws rotating in same direction and has per screw shaft one or more of the comb elements according to the invention, as described above. The comb elements in accordance with the present invention may hereby be arranged, as viewed in transport direction of the extruder, downstream of a feed device for introduction of fiber material, whereby the separation and homogenization effect can be varied and suited by the number of sequentially disposed comb elements per screw shaft.

It is normally recommended to arrange the comb elements according to the invention at a certain distance in axial direction of the screw shaft and, optionally, to dispose further alternative mixing elements between the comb elements according to the invention. It may, e.g., be recommended hereby to arrange on the screw shafts screw elements for coarse distribution of the fiber parts and then the comb elements according to the invention for homogenization of the fiber material in the plastic material.

The present invention further relates to the use of the comb elements according to the invention for separation and incorporation of fibers in plastic melts in general, whereby the invention is especially suitable for the temperature-sensitive natural fibers. Used as natural fibers are, in particular flax fibers, hemp fibers, kenaf fibers, sisal fibers, coco fibers, cotton fibers and jute fibers. Of course, inorganic and synthetic organic fibers may also be processed at great success with the screw elements according to the invention. This is true in particular for glass fibers and carbon fibers as well as aramide fibers.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a general illustration of four variations of involute surfaces of closely intermeshing comb elements constructed in accordance with the present invention;

FIG. 2 is a photographic representation of a detail, on an enlarged scale, of a comb element according to the present invention;

FIG. 3 is a schematic partial illustration of surface structure element of a comb element according to the invention;

FIG. 4 shows two perspective views of comb elements according to FIG. 1 mounted onto screw shafts of a twin-screw extruder; and

FIG. 5 illustrates a test arrangement for checking the efficacy of a comb element according to the present invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

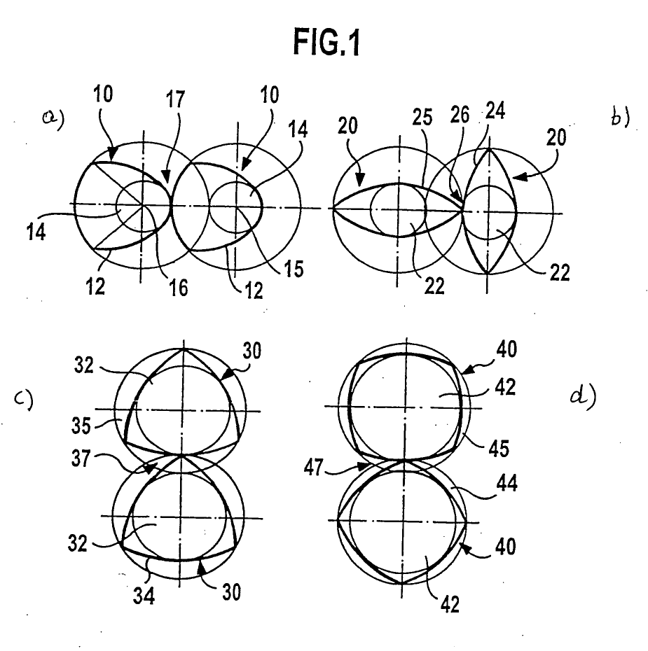

Turning now to the drawing, and in particular to FIG. 1, there are shown four different versions of involute surfaces of comb elements according to the present invention which form one, two, three or four melt passages in the twin-screw extruder in view of their different involute surfaces. FIG. 1 shows hereby in the left hand upper illustration, marked “a”, two comb elements 10 interacting with their involute surfaces 12 and forming on the connecting line of both axes of the shafts 14 an intermeshing zone 17 at a preferred maximum distance of 5 mm in accordance with the invention.

As a consequence of providing surface structure elements (not shown in detail here) in the involute surface 12 of the comb elements 10, fibers from the fiber strand introduced into the extruder can be combed out and these fibers can be separated and distributed into the surrounding plastic melt.

The same is effected in a further embodiment of the comb elements 20 according to the invention (upper right-hand in FIG. 1, and marked “b”) which are mounted on extruder shafts 22 and roll off one another with their involute surfaces 24, 25 and form on the connection axis of the shaft centers an intermeshing zone 26 where the outcomb effect and distribution process takes place as described in conjunction with the afore-described version.

Both comb elements 20 form two melt channels, while the version, illustrated in the lower left-hand corner of FIG. 1, marked “c”, has three melt channels. Involute surfaces 34, 35 of both comb elements 30 roll off one another and form in the connecting line of the centers of the shaft 32 an intermeshing zone 37 in which the outcomb effect of the fibers takes place. A further variation is finally shown in the lower right-hand corner of FIG. 1, marked “d”, with comb elements 40 arranged on shafts 42. As a consequence of the configuration with four tips on the outer circumference of the comb elements, four channels are formed and the involute surfaces 44, 45 roll off one another and form an intermeshing zone 47 in which the afore-described outcomb process takes place.

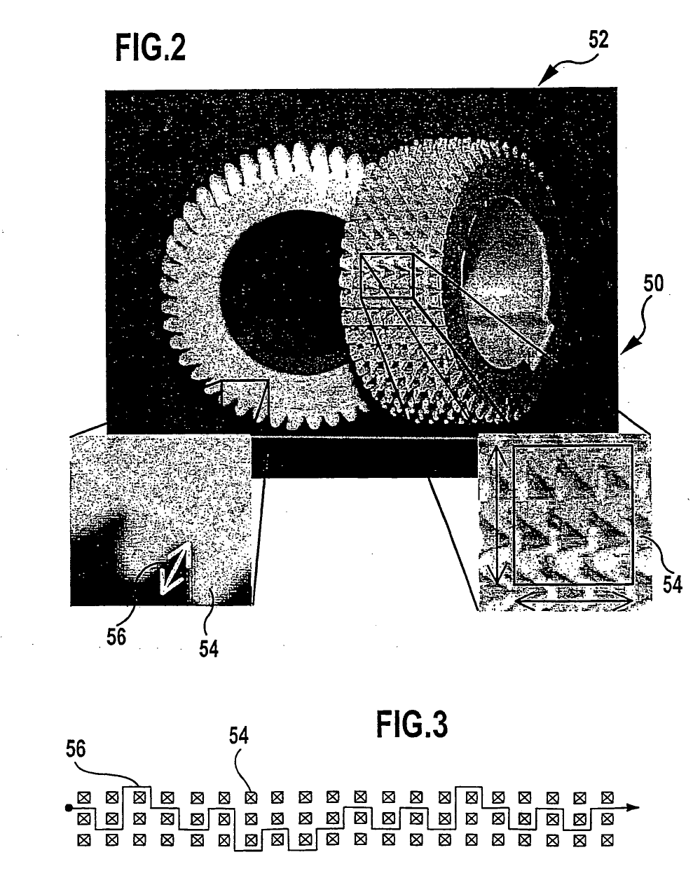

FIG. 2 shows in detail a preferred embodiment of a comb element 50 which assumes as involute surface a circular shape in which substantially pyramid-shaped teeth are incorporated in seven parallel rows. As a consequence of the pyramid shape, the cross sectional areas of the individual surface structure elements 54 taper substantially steadily in the direction of the involute surface. In the present example, the cross sectional area of the tip, i.e. the pointed area adjacent to the involute surface 52, is in the range of less than 1 mm². The depth of the teeth is below 5 mm. In the present case, it is about 1.5 mm which corresponds approximately to the distance between the tips of the teeth.

The pyramid structure, shown here, of the surface structure elements can be realized not only in the circular shape of the involute surface of a comb element of the present invention but is also possible in the variations shown in FIG. 1.

The pyramid shape or truncated pyramid shape, shown here, can be easily modified without substantial change to the efficacy of the comb element according to the invention with respect to the separation of fibers from the fiber strand, e.g. to a truncated cone shape or also other irregular configurations, whereby the pyramid shape has been selected in the present example of FIG. 2 because of the simple manufacture.

In order to optimize the outcomb effect of the comb element according to the invention, it is important to taper the cross section of the element in the direction toward the involute surface 52 so that the surface structure elements have a substantial needle shape, or, as shown here, pyramid shape. As a result, the tips of the surface structure elements penetrate easier the fiber bundle and are able to easily comb out fibers therefrom.

The selection of the depth of the surface structure elements or the teeth is determined by the desire to release the fibers again to the surrounding polymer melt during outcombing effect so that fibers do not adhere to the bottom of the surface structure elements to clog them. This is also assisted by the tapering shape of the surface structure elements which allow easier disengagement of fibers interlaced between the individual surface structure elements.

As a result of theoretic considerations, based on typical fiber thicknesses of reinforced fibers 56 to be processed, a mathematical model can be calculated to establish that a minimum number of looping alternatives of 10⁸ is advantageous when the density of surface structure elements, as required for the desired outcomb effect, is 100 mm² per area unit. Hereby, as shown in FIG. 3, the calculation is based on 20 surface structure elements 54 in each of three rows which have each four looping alternatives. Currently preferred is a minimum number of looping alternatives of 10¹².

When the calculation is based on a surface element of 100 mm², a minimum coverage of this area with 7 to 9 surface structure elements is attained.

Due to the fact that the surface structure elements do not project beyond the involute surface 52 of the comb element 50, no cutting action can take place because the neighboring comb element, disposed on the parallel screw shaft, rolls off with its involute surface upon the involute surface 52 of the comb element 50, so that the afore-described outcomb effect is maintained in the intermeshing zone between both comb elements.

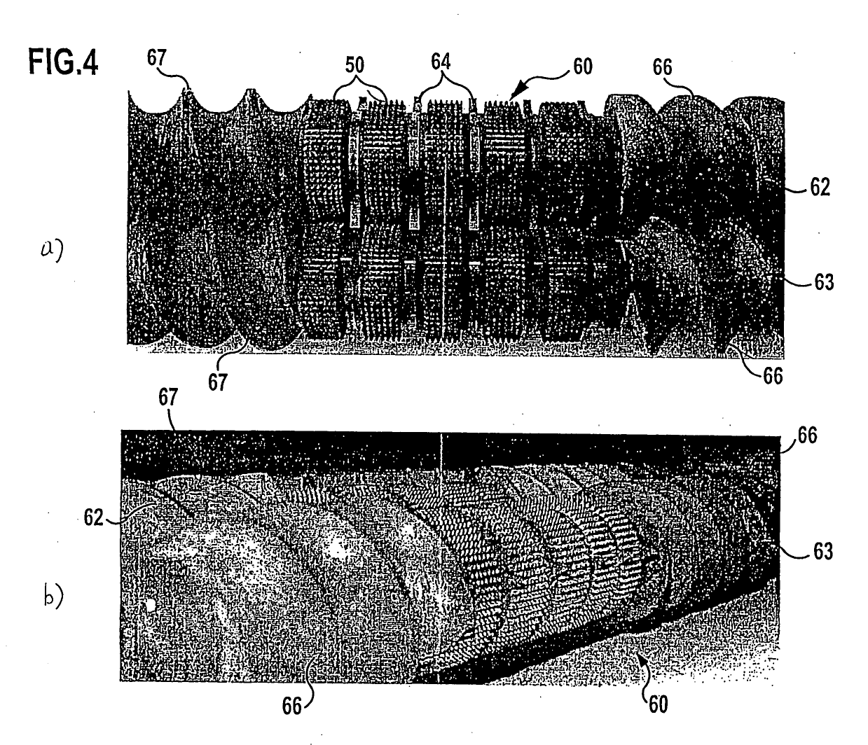

FIG. 4 show two perspective illustrations, marked “a” and “b”, of a photographic representation of a possible disposition of the comb element 50 according to the invention in a twin-screw extruder 60 having two screw shafts 62, 63. Comb elements 50 according to the invention are arranged in alignment on both shafts 62, 63, respectively, and kept at axial distance from one another by further screw elements 64. The screw elements 64 in the form of double-tooth elements may be used for coarse distribution, and a fine distribution takes place in the present example of FIG. 4 in alternating fashion with the coarse distribution.

Conventional helical conveyor screw elements (screw flights) can be positioned to the left and right of the comb elements 50 according to the invention, as shown in FIG. 4 by way of screw elements 66, 67.

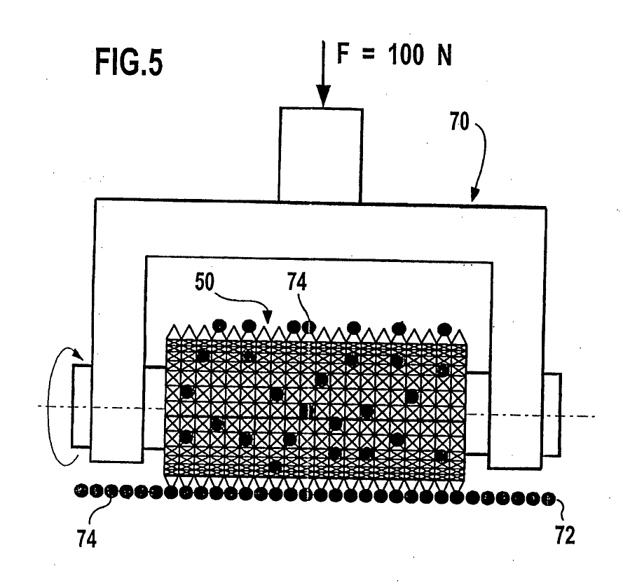

In order to better demonstrate the outcomb effect of the comb elements according to the invention and to quantify it, reference is now made to FIG. 5 to describe a test by which the efficiency of a comb element according to the invention can be determined.

Especially the needle structure of these surface structure elements is evident in comparison to conventional hedgehog, spiral, tooth and turbine mixing elements whose action is limited to kneading, mixing and/or conveying functions.

At test, a monolayer 72 of elastomeric plastic particles 74 (e.g. of ethylene/octene copolymer of the type Engage 8200) is lined up, having a diameter of 2 mm. The mounting 70, shown in FIG. 5, is used to guide the rotatably supported comb elements 50 according to the invention, juxtaposed at a preset test width, with a predetermined force (F=100 N) across the monolayer 72. An accumulation outcome of at least 5% is desired, when the mounting 70 travels at a distance which corresponds to the circumference of the involute surface of the used comb elements 50. The travel speed is not critical per se but a value of about 10 cm/30 s is recommended.

The comb elements according to the invention are suitable in particular for processing natural fiber materials into natural fiber composites, whereby the flexible natural fibers are combed apart in a homogenous and gentle manner and incorporated at extremely even distribution into the polymer melt. In particular, it has been observed that the finished components contain more or less only mono-filament fibers and no longer any fiber agglomerates or fiber clusters, whereby the fraction of long fibers (I_{F}>1 mm) is at least 20 weight-%.

About 30 weight-% of retting flax have been incorporated in produced sample plates with a polypropylene matrix modified with 1 phr maleic acid hydride. The plates made subsequently in a pressing operation have a thickness of 3 mm and are characterized by superior mechanical properties when exposed to static as well as dynamic load. Tensile strength and impact resistance of samples, as determined transversely and longitudinally in extrusion direction, results in mean characteristic values in the range of σ_{b}=93N/mm² and aₖ=18 kj/m².

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A comb element with closely intermeshing involute surface for a twin-screw extruder with closely intermeshing screws rotating in same direction, said comb element comprising on its involute surface a plurality of surface structure elements which are set back from the involute surface.

2. The comb element of claim 1, wherein the surface structure elements extend inwardly from the involute surface in perpendicular relationship to a tangential direction at a maximum of 5 mm.

3. The comb element of claim 1, wherein the surface structure elements have a surface area of ≦2 mm² at their tip adjacent to the involute surface.

4. The comb element of claim 1, wherein the surface structure elements have a surface area of ≦1.8 mm² at their tip adjacent to the involute surface.

5. The comb element of claim 1, wherein the surface structure elements have each a base body constructed to resemble the shape of a member selected from the group consisting of pyramid, truncated pyramid, truncated cone, cylinder, block shape, and combinations thereof.

6. The comb element of claim 1, wherein the surface structure elements have each a base body defined by a bottom and a pointed end, said base body having a cross section which decreases from the bottom face to the pointed end.

7. The comb element of claim 6, wherein the base body is configured of substantial conical shape.

8. The comb element of claim 1, wherein the surface structure elements are arranged at a surface density such as to realize at least 10⁸ looping possibilities per area unit of 100 mm² for a flexible fiber.

9. The comb element of claim 1, wherein the involute surface is so constructed as to be spaced from an involute surface of a further said comb element at a distance of a maximum of 5 mm, when the comb element and the further comb element are mounted on parallel screw shafts.

10. The comb element of claim 1, wherein the surface structure elements are configured such as to maintain a minimum distance in relation to the surface structure elements of an interacting further said comb element to avoid any cutting action between the comb element and the further comb element.

11. A twin-screw extruder, comprising at least two closely intermeshing screws rotating in same direction for advancing a plastic melt in a transport direction, each of the screws supporting at least one comb element defining an involute surface and comprising on its involute surface a plurality of surface structure elements which are set back from the involute surface.

12. The twin-screw extruder of claim 11, wherein the comb element, as viewed in the transport direction, is arranged downstream of a feed device for introduction of fiber material.

13. The twin-screw extruder of claim 12, wherein the fiber material includes natural fibers.

14. The twin-screw extruder of claim 13, wherein the natural fibers are selected from the group consisting of flax fibers, hemp fibers, kenaf fibers, sisal fibers, coco fibers, cotton fibers and jute fibers.

15. The twin-screw extruder of claim 12, wherein the fiber material includes inorganic fibers.

16. The twin-screw extruder of claim 15, wherein the inorganic fibers are selected from the group consisting of glass fibers and carbon fibers.

17. The twin-screw extruder of claim 12, wherein the fiber material includes aramide fibers.

18. The twin-screw extruder of claim 12, wherein the fiber material has fibers with a mean fiber length of at least 1 mm after a compounding process.

19. The twin-screw extruder of claim 11, wherein each of the screws includes a plurality of said comb element arranged behind one another.

20. The twin-screw extruder of claim 19, wherein the comb elements are arranged on the screw in axial spaced-apart relationship.

21. The twin-screw extruder of claim 12, wherein each of the screws supports a screw element disposed in the transport direction downstream of the feed device for fiber material to realize a coarse distribution of the fiber material, said comb element constructed for implementing a homogenous distribution of the fiber material in the plastic melt.

22. Use of a comb element defining an involute surface and comprising on its involute surface a plurality of surface structure elements which are set back from the involute surface, for separation and incorporation of fibers in a plastic melt.

23. A screw of a twin-screw extruder, comprising a screw body; and at least one comb element disposed on the screw body and defining an involute surface, said comb element comprising on its involute surface a plurality of surface structure elements which are set back from the involute surface.

24. The screw of claim 23, wherein the surface structure elements extend inwardly from the involute surface in perpendicular relationship to a tangential direction at a maximum of 5 mm.

25. The screw of claim 23, wherein the surface structure elements have a tip adjacent to the involute surface and having a surface area of ≦2 mm².

26. The screw of claim 23, wherein the surface structure elements have a tip adjacent to the involute surface and having a surface area of ≦1.8 mm².

27. The screw of claim 23, wherein the surface structure elements have each a base body constructed to resemble the shape of a member selected from the group consisting of pyramid, truncated pyramid, truncated cone, cylinder, block shape, and combinations thereof.

28. The screw of claim 23, wherein the surface structure elements have each a base body defined by a bottom and a pointed end, said base body having a cross section which decreases from the bottom face to the pointed end.

29. The screw of claim 28, wherein the base body is configured of substantial conical shape.

30. The screw of claim 23, wherein the surface structure elements are arranged at a surface density such as to realize at least 10⁸ looping possibilities per area unit of 100 mm² for a flexible fiber.
